(19) United States
(12) Patent Application Publication
(10) Pub. No.: US 2026/0280191 A1
(43) Pub. Date: Sep. 17, 2026

(54) CONNECTOR STRUCTURE

(71) Applicant: TOYOTA JIDOSHA KABUSHIKI KAISHA, Toyota-shi (JP)

(72) Inventor: Manabu SASAKI, Hashima-shi (JP)

(73) Assignee: TOYOTA JIDOSHA KABUSHIKI KAISHA, Toyota-shi (JP)

(21) Appl. No.: 19/453,519

(22) Filed: Jan. 20, 2026

(30) Foreign Application Priority Data
Mar. 11, 2025 (JP) 2025-038817

(51) Int. Cl. H01R 13/639

(52) U.S. Cl. CPC H01R 13/639

(57) ABSTRACT

The connector structure includes a first connector including a first mating portion including a first terminal, a slide mechanism including a first slide member, and a second connector including a second mating portion including a second terminal electrically connected to the first terminal. The second housing moves in an opening direction relative to the second slide member mounted on the mounting portion and causes the second housing to pressurize the first slide member, and the second housing and the first slide member move integrally in the opening direction. When the second housing and the first slide member move integrally in the opening direction, the operation of the second housing exposes the second mating surface and an operation to expose the first mating surface, simultaneously exposing the first mating surface and the second mating surface and positioning them facing each other in the insertion/removal direction, thereby performing an opening operation.

The present application claims priority to and incorporates by reference the entire contents of Japanese Patent Application No. 2025-038817 filed in Japan on Mar. 11, 2025.

### BACKGROUND

The present disclosure relates to a connector structure.

JP4209786B2 discloses a connector structure that opens a cover by mounting a female connector, whose opening is covered by the cover, onto a mounting base.

### SUMMARY

The configuration described in JP4209786B2 lacks a structure protecting the male connector side, posing a risk of foreign matter adhering to the mating portion of the male connector when not connected.

There is a need for a connector structure that may suppress the adhesion of foreign matter to the mating surface of the connector.

According to one aspect of the present disclosure, there is provided a connector structure including: a first connector including a first mating portion including a first terminal; a slide mechanism including a first slide member functioning as a cover structure for the first connector; and a second connector including a second mating portion including a second terminal electrically connected to the first terminal, the second connector connecting to the first connector in a state that the second connector is mounted on the slide mechanism, wherein the first connector includes a first housing configured to accommodate the first mating portion, the first housing being fixed to the slide mechanism, the first slide member is a shield plate configured to cover a first mating surface of the first connector, and slide relative to the first housing in an opening/closing direction perpendicular to an insertion/removal direction between the first connector and the second connector, the second connector includes a second housing that accommodates the second mating portion, the second housing including an opening exposing a second mating surface of the second connector, and a second slide member that is a shield plate attached to the second housing to cover the opening, functions as a cover structure for the second connector, and covers the second mating surface, the second slide member being configured to slide relative to the second housing in the opening/closing direction, the slide mechanism includes a mounting portion configured to restrict the second slide member from moving in the opening/closing direction when the second slide member is mounted upon connecting the first connector and the second connector, when the second housing moves in the opening direction relative to the second sliding member mounted on the mounting portion, the second housing presses against the first sliding member and causes the second housing and the first sliding member to move integrally in the opening direction, and when the second housing and the first slide member move integrally in the opening direction, the operation of the second housing becomes an operation to expose the second mating surface and an operation to expose the first mating surface, simultaneously exposing the first mating surface and the second mating surface and positioning them facing each other in the insertion/removal direction, thereby performing an opening operation.

### BRIEF DESCRIPTION OF THE DRAWINGS

FIG. 1 is a perspective view schematically illustrating the connector structure in an embodiment;

FIG. 2 is a view illustrating the state where the female connector and the male connector are connected;

FIG. 3 is a cross-sectional view illustrating the connector structure before connection;

FIG. 4 is a cross-sectional view illustrating the connector structure after connection;

FIG. 5A shows a view of the slide mechanism and the female connector from the insertion/removal direction;

FIG. 5B shows the spring structure within the slide mechanism;

FIG. 5C shows the state where the mating surface of the female connector is exposed;

FIG. 6A shows the male connector as viewed from the insertion/removal direction;

FIG. 6B shows the spring structure within the male connector;

FIG. 6C shows the state where the mating surface of the male connector is exposed;

FIG. 7A shows the state where the second slide member is mounted on the mounting portion;

FIG. 7B shows the state where the mating surfaces face each other in the insertion/removal direction;

FIG. 8 schematically shows the connector structure in the first modified example; and

FIG. 9 schematically shows the connector structure in the second modified example.

### DETAILED DESCRIPTION

The connector structure in the embodiments of the present disclosure will now be described in detail. Note that the present disclosure is not limited to the embodiments described below.

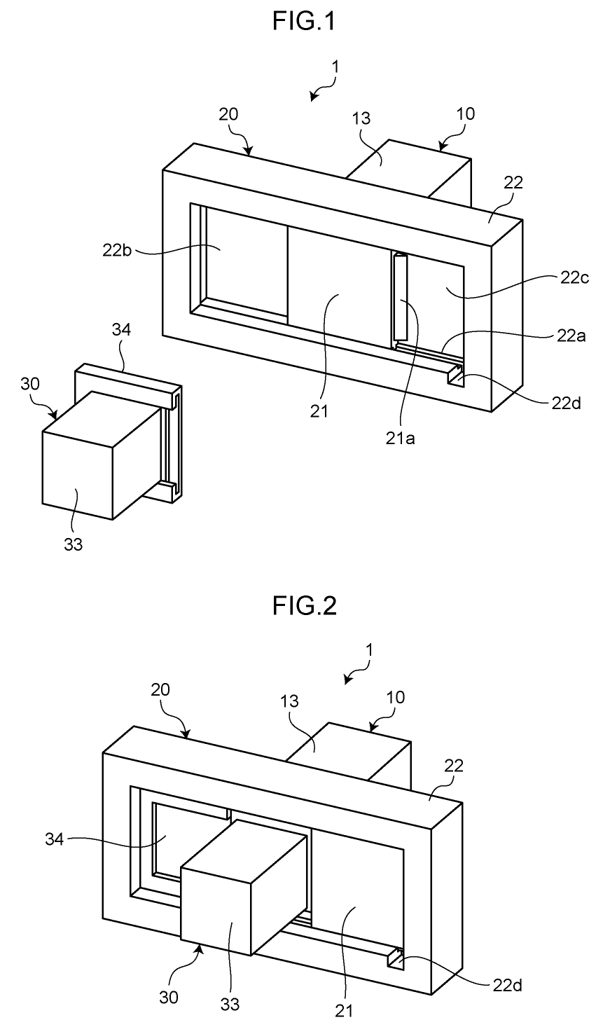

FIG. 1 is a schematic perspective view illustrating the connector structure in an embodiment. The connector structure 1 includes a connector mounted on an electric vehicle. The connector structure 1 is configured to suppress the inhibition of connector mating and terminal connection by foreign matter adhesion during the mating and disconnection operations of the connector, which are anticipated in highly contaminated environments.

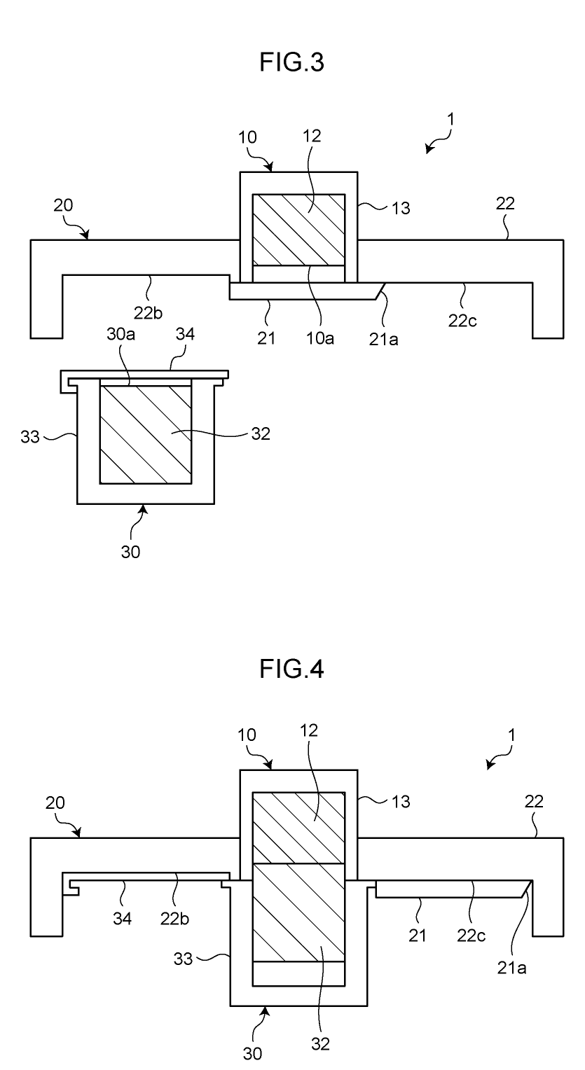

The connector structure 1 includes a female connector 10, a slide mechanism 20, and a male connector 30. The female connector 10 and slide mechanism 20 are installed on the electric vehicle, while the male connector 30 is installed externally to the electric vehicle. The female connector 10 is the vehicle-side connector, and the male connector 30 is the external device-side connector. As illustrated in FIGS. 1 to 4, in the connector structure 1, the female connector 10 and the male connector 30 are electrically connected while the male connector 30 is mounted on the slide mechanism 20.

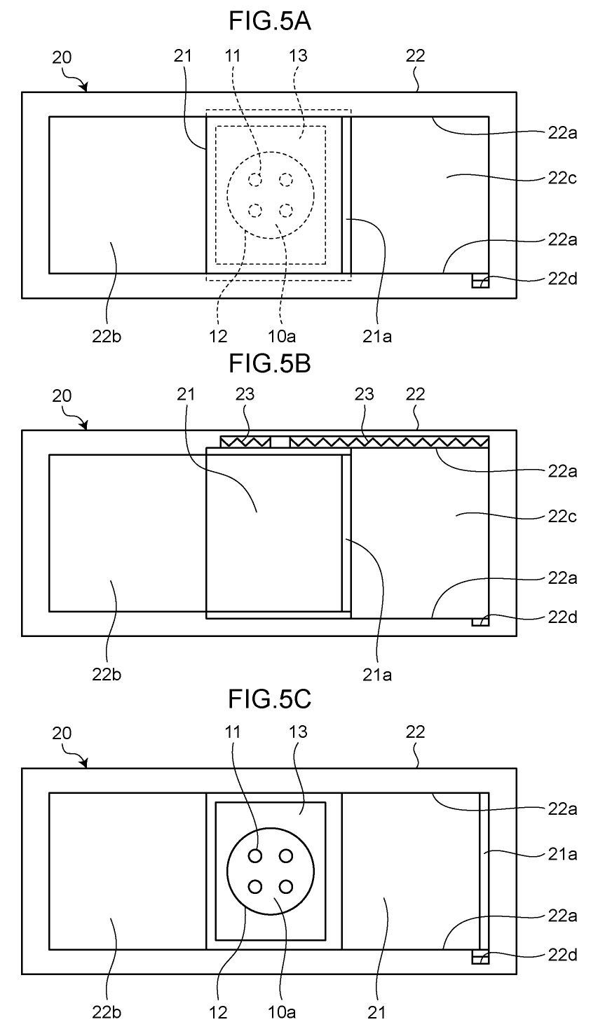

The female connector 10, as illustrated in FIGS. 1 to 5, includes a female terminal 11, a first mating portion 12 including the female terminal 11, and a first housing 13 accommodating the first mating portion 12. The female terminal 11 is the first terminal. The first mating section 12 includes the first mating surface 10a, which is the mating surface of the female connector 10. The first housing 13 is fixed to the slide mechanism 20.

The slide mechanism 20, as illustrated in FIGS. 1 to 5, includes a first slide member 21, a support member 22, and a first spring 23.

The first sliding member 21 is a shield plate for protecting the mating surface of the female connector 10 from foreign objects and functions as a cover structure for the female connector 10. The first sliding member 21 is a shield plate covering the first mating surface 10a and performs a shielding function to prevent foreign objects from entering the interior of the first mating portion 12. The first sliding member 21 slides relative to the first housing 13 in the opening/closing direction. The opening/closing direction is perpendicular to the insertion/removal direction between the female connector 10 and the male connector 30 and is parallel to the first mating surface 10a. The first sliding member 21 is connected to the support member 22 via the first spring 23.

The first slide member 21 has a wiper portion 21a provided at its movable starting point. The wiper portion 21a is a rubber-made part for removing foreign matter adhering to the mating opening of the connector.

The support member 22 is the component to which the first housing 13 is fixed. The support member 22 has a guide member 22a, a mounting portion 22b, a slide surface 22c, and an ejection portion 22d.

The guide portion 22a is the part that slides the first sliding member 21 in the opening/closing direction perpendicular to the insertion/removal direction of the male connector 30. The opening/closing direction includes an open direction exposing the mating surface of the female connector 10 and a closed direction covering the mating surface of the female connector 10. The open direction is parallel to and in the same direction as the mating surface of the female connector 10.

The receiving portion 22b is the part where the second sliding member 34, provided on the male connector 30, is mounted when connecting the female connector 10 and the male connector 30. The receiving portion 22b faces the second sliding member 34 in the insertion/removal direction and restricts the movement of the second sliding member 34 in the opening/closing direction.

The sliding surface 22c is the plane along which the first sliding member 21 slides. Foreign matter adhering to the sliding surface 22c is removed by the wiper portion 21a as the first sliding member 21 moves in the opening direction.

The discharge portion 22d is the area for discharging foreign matter removed by the wiper portion 21a from the slide mechanism 20.

The first spring 23 applies a biasing force in the closing direction, which shields the first engagement surface 10a within the opening/closing direction, to the first slide member 21. The first spring 23 is positioned between the first slide member 21 and the support body 22 in the opening/closing direction. One end of the first spring 23 is connected to the first slide member 21, and the other end of the first spring 23 is connected to the support body 22. The first slide member 21 is biased toward the closing direction, which shields the first engagement surface 10a, by the biasing force of the first spring 23. The first slide member 21 may slide in the opening direction to expose the first mating surface 10a against the biasing force of the first spring 23. The first slide member 21 slides by being pushed in a direction parallel to the first mating surface 10a, thereby exposing the first mating surface 10a. The first spring 23 is a member that protects the first mating surface 10a by covering the first slide member 21 in response to the action of disengaging the male connector 30. During disengagement of the male connector 30, the first spring 23 automatically covers the mating surface of the female connector 10 by its biasing force.

The male connector 30, as illustrated in FIGS. 1 to 4 and 6, includes a male terminal 31, a second mating portion 32 including the male terminal 31, a second housing 33 accommodating the second mating portion 32, a second slide member 34 attached to the second housing 33, and a second spring 35.

The male terminal 31 is a second terminal electrically connected to the female terminal 11. The second mating section 32 includes the second mating surface 30a, which is the mating surface of the male connector 30.

The second housing 33 has an opening exposing the second mating surface 30a and a flange portion retaining the second slide member 34. The second housing 33 supports the second mating portion 32 so that it may move back and forth in the insertion/removal direction relative to the opening.

The second slide member 34 is a shield plate for protecting the second mating surface 30a from foreign objects and functions as a cover structure for the male connector 30. The second slide member 34 is a shield plate covering the second mating surface 30a and performs a shielding function to prevent foreign objects from entering the interior of the second mating portion 32. The second slide member 34 is mounted on the second housing 33 to block the opening and is biased by the force of the second spring 35 toward the closed direction, shielding the second mating surface 30a. The second slide member 34 slides relative to the second housing 33 in the opening/closing direction.

The second slide member 34 is connected to the second housing 33 via the second spring 35.

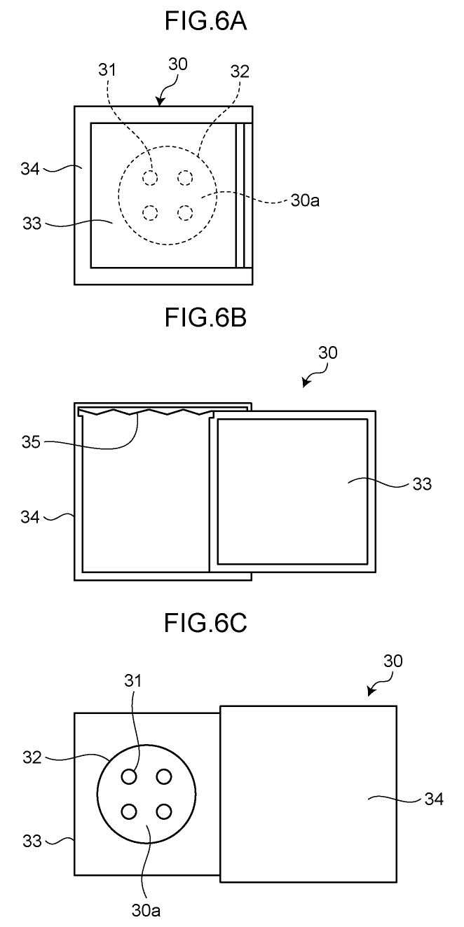

The second spring 35 applies a closing force in the closing direction, which shields the second mating surface 30a, to the second slide member 34. As illustrated in FIG. 6B, the second spring 35 is positioned between the second housing 33 and the second slide member 34 in the opening/closing direction, with one end connected to the second housing 33 and the other end connected to the second slide member 34. Upon disengagement of the male connector 30, the second slide member 34 automatically shields the second mating surface 30a due to the biasing force of the second spring 35.

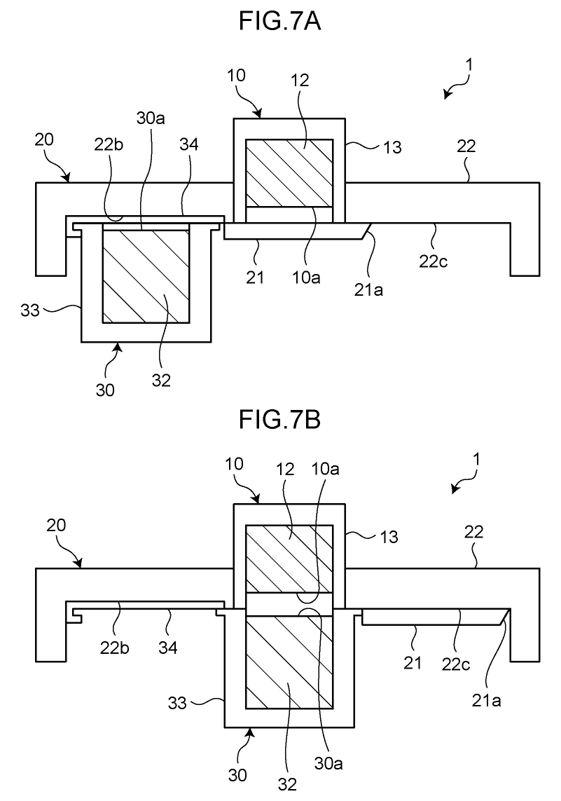

As illustrated in FIG. 7A, when the second slide member 34 is mounted on the mounting portion 22b, the second housing 33 may move in the opening direction relative to the second slide member 34. From this state, the second housing 33 moves in the opening direction against the force of the second spring 35. In this case, the second housing 33 presses the first slide member 21 in the opening direction, and the second housing 33 and the first slide member 21 move integrally in the opening direction. When the second housing 33 and the first slide member 21 move integrally in the opening direction, the action of the second housing 33 is an action that exposes the second mating surface 30a and an action that exposes the first mating surface 10a, such that the exposure of the first mating surface 10a and the exposure of the second mating surface 30a occur simultaneously. In other words, this action of the second housing 33 is an opening action that simultaneously exposes the first mating surface 10a and the second mating surface 30a and opposes them in the insertion/removal direction. The sliding motion of the second housing 33 in the opening direction includes an action to scrape off foreign matter adhering to the sliding surface 22c. The first sliding member 21 scrapes off foreign matter to clean the sliding surface 22c and also acts as a shielding structure to prevent the foreign matter scraped off by this sliding motion from moving to the vicinity of the first mating portion 12 and the second mating portion 32.

As illustrated in FIG. 7B, with the exposed, clean first mating surface 10a and second mating surface 30a facing each other in the insertion/removal direction, the second mating portion 32 protrudes from the opening of the second housing 33 and mates with the first mating portion 12. The male connector 30 includes a lever member that pushes the second mating portion 32 in the insertion direction. From the state illustrated in FIG. 7B, when the user operates the lever member, the second mating portion 32 protrudes from the opening of the second housing 33, enters the interior of the first housing 13, and mates with the first mating portion 12. As illustrated in FIG. 4, the female terminal 11 and the male terminal 31 are electrically connected when the first mating portion 12 and the second mating portion 32 engage. When disconnecting the male connector 30, the second mating portion 32 moves in the withdrawal direction when the user operates the lever member.

As described above, according to the embodiment, the first slide member 21 prevents foreign matter adhering near the first mating surface 10a from entering the interior of the first mating portion 12. Consequently, during connector attachment/detachment operations, when the second housing 33 of the male connector 30 is manually slid, the clean first mating surface 10a and second mating surface 30a, free of foreign matter, may be exposed as opposing surfaces.

Furthermore, in the connector structure 1, either the female connector 10 or the male connector 30 may serve as the vehicle-side connector. The connector structure 1 may also be configured such that the male connector 30 is the vehicle-side connector and the female connector 10 is the external device-side connector.

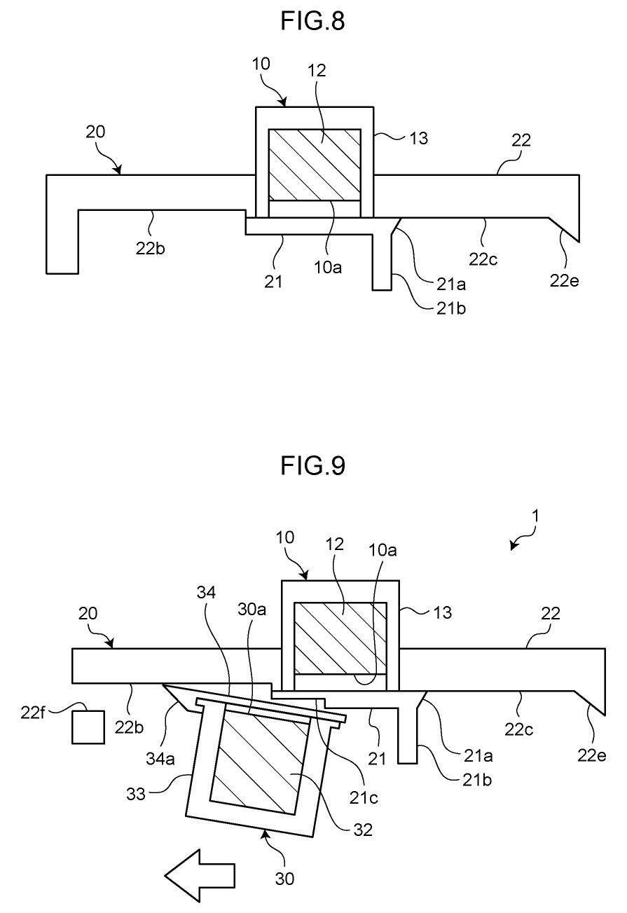

Furthermore, the connector structure 1 may be configured as the modified examples illustrated in FIGS. 8 and 9. As illustrated in FIG. 8, in the connector structure 1 of the first modified example, the first slide member 21 has a wall portion 21b, and the support member 22 has an inclined surface 22e. The wall portion 21b is structured to prevent foreign matter removed by the wiper portion 21a from adhering to the first mating surface 10a. The inclined surface 22e is structured to facilitate the discharge of foreign matter removed from the slide surface 22c by the wiper portion 21a to the exterior of the support member 22. According to the first modified example, foreign matter adhering to the slide mechanism 20 is pushed out by the sliding motion of the first slide member 21, facilitating discharge from the inclined surface 22e, which is the foreign matter discharge location. Furthermore, the wall portion 21b prevents the extruded foreign matter from moving toward the connector side. Consequently, the number of foreign particles present near the connector mating surface is reduced, preventing foreign matter from adhering to the connector mating surface or its vicinity during connector disengagement. This reduces the risk of foreign matter adhesion during connector connection operations while enabling efficient expulsion of adhered foreign matter.

As illustrated in FIG. 9, in the connector structure 1 of the second modified example, the first slide member 21 has a step portion 21c, the support member 22 has an opening 22f, and the second slide member 34 has an inclined portion 34a. The step portion 21c is a part for suppressing interference with the second slide member 34. The opening 22f and the inclined portion 34a constitute a structure for discharging foreign matter adhered to the mounting portion 22b. The male connector 30 contacts the inclined portion 34a of the second slide member 34 against the mounting portion 22b, scraping out foreign matter adhered to the mounting portion 22b and discharging it through the opening 22f. When mounting the male connector 30 onto the slide mechanism 20, the swipe action of the male connector 30 scrapes foreign matter on the mounting portion 22b toward the opening 22f. Furthermore, when the second slide member 34 is mounted onto the mounting portion 22b, the inclined portion 34a is housed within the opening 22f. According to the second modified example, even if foreign matter adheres to the mounting portion 22b, it may be removed by the second slide member 34 when mounting the male connector 30 onto the slide mechanism 20. This suppresses the intrusion of foreign matter into the connector's mating section and suppresses malfunctions caused by foreign matter during connector connection operations.

This disclosure suppresses the adhesion of foreign matter to the mating surface of the connector.

Although the disclosure has been described with respect to the specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector structure comprising:
a first connector including a first mating portion including a first terminal;
a slide mechanism including a first slide member functioning as a cover structure for the first connector; and
a second connector including a second mating portion including a second terminal electrically connected to the first terminal, the second connector connecting to the first connector in a state that the second connector is mounted on the slide mechanism, wherein
the first connector includes a first housing configured to accommodate the first mating portion, the first housing being fixed to the slide mechanism,
the first slide member is a shield plate configured to
cover a first mating surface of the first connector, and
slide relative to the first housing in an opening/closing direction perpendicular to an insertion/removal direction between the first connector and the second connector,
the second connector includes
a second housing that accommodates the second mating portion, the second housing including an opening exposing a second mating surface of the second connector, and
a second slide member that is a shield plate attached to the second housing to cover the opening, functions as a cover structure for the second connector, and covers the second mating surface, the second slide member being configured to slide relative to the second housing in the opening/closing direction,
the slide mechanism includes a mounting portion configured to restrict the second slide member from moving in the opening/closing direction when the second slide member is mounted upon connecting the first connector and the second connector,
when the second housing moves in the opening direction relative to the second sliding member mounted on the mounting portion, the second housing presses against the first sliding member and causes the second housing and the first sliding member to move integrally in the opening direction, and
when the second housing and the first slide member move integrally in the opening direction, the operation of the second housing becomes an operation to expose the second mating surface and an operation to expose the first mating surface, simultaneously exposing the first mating surface and the second mating surface and positioning them facing each other in the insertion/removal direction, thereby performing an opening operation.

2. The connector structure according to claim 1, wherein
the slide mechanism includes a first spring configured to bias the first slide member toward a first closing direction of the opening/closing direction for shielding the first mating surface,
the second connector includes a second spring configured to bias the second slide member toward a second closing direction of the opening/closing direction for shielding the second mating surface,
the first sliding member is configured to slide against a biasing force of the first spring in the opening direction to expose the first mating surface, and
the second housing is configured to slide against a biasing force of the second spring in the opening direction to expose the second mating surface.

3. The connector structure according to claim 1, wherein
the second mating portion protrudes from the opening of the second housing and mates with the first mating portion while the first mating surface and the second mating surface, exposed by the operation of the second housing, face each other in the insertion/removal direction, thereby electrically connecting the first terminal and the second terminal.

4. The connector structure according to claim 2, wherein
the second mating portion protrudes from the opening of the second housing and mates with the first mating portion while the first mating surface and the second mating surface, exposed by the operation of the second housing, face each other in the insertion/removal direction, thereby electrically connecting the first terminal and the second terminal.
